(19) United States
(12) Patent Application Publication
(10) Pub. No.: US 2014/0210795 A1
(43) Pub. Date: Jul. 31, 2014

(54) Control Assembly for a Motor Vehicle and Method for Operating the Control Assembly for a Motor Vehicle

(71) Applicants: Stefan Mattes, Stuttgart (DE); Stefan Jansen, Pforzheim (DE); Roland Stiegler, Esslingen (DE); Volker Entenmann, Affalterbach (DE); Susanne Schild, Gaertringen (DE)

(72) Inventors: Stefan Mattes, Stuttgart (DE); Stefan Jansen, Pforzheim (DE); Roland Stiegler, Esslingen (DE); Volker Entenmann, Affalterbach (DE); Susanne Schild, Gaertringen (DE)

(73) Assignee: Daimler AG, Stuttgart (DE)

(21) Appl. No.: 14/343,620

(22) PCT Filed: Sep. 5, 2012
(86) PCT No.: PCT/EP2012/003712

§ 371 Date: Mar. 7, 2014

(30) Foreign Application Priority Data
Sep. 8, 2011 (DE) 10 2011 112 563.2
Sep. 8, 2011 (DE) 10 2011 112 564.0

(51) Int. Cl. G06F 3/042

(52) U.S. Cl. CPC G06F 3/0421
USPC 345/175

(57) ABSTRACT

A control assembly for a motor vehicle is arranged so that a control action carried out by a finger is able to be detected. The control assembly includes a control device and a selection element, on which a finger is able to be positioned to make a selection. The selection element is arranged in a predetermined spatial way with respect to the control device either next to or directly next to the control device. The control device is formed to detect a position of the finger on the selection element and to differentiate the control action depending on the detected position.

### BACKGROUND AND SUMMARY OF THE INVENTION

The present invention relates to a control assembly for a motor vehicle, with which control actions carried out by a finger are detectable, and a method to operate the control assembly for a motor vehicle.

Modern motor vehicles comprise corresponding control assemblies, with which, for example, functional units of the motor vehicle can be operated by means of a touch pad or a touch screen. These touch pads or touch screens can be allocated to an instrument cluster of a motor vehicle. For example, a navigation system, a mobile telephone coupled to the vehicle, an information system of the vehicle or similar can be operated with a touch screen. A corresponding control action is carried out by an operator or the vehicle driver by means of the touch screen by positioning his finger on the touch screen in order to select the depicted selection element. In order to do this the driver normally turns his gaze from the road and directs it towards the touch screen. This causes a clear reduction in safety while driving the vehicle. Otherwise, the driver must interrupt driving the motor vehicle in order to be able to operate the touch screen accordingly.

An operation of such control assemblies usually occurs through a finger of an operator, which is positioned on the touch pad or touch screen. The position of the finger is detected, for example, with capacitive sensors.

Other known technical approaches consist in extending a light curtain that is parallel to a control surface and detecting the position of the finger through the evaluation of the light reflected by the finger. However, these approaches have the disadvantage that the sensor or at least part of the sensor optics protrudes from the control surface, which is again not desirable for design reasons.

Finally, the possibility exists of using a divided sensor system, in which the position of the finger on the corresponding selection element is detected with a camera arranged above it. Such systems, however, are difficult to integrate into a motor vehicle, are extremely cost-intensive and are susceptible to shadowing of the finger to be detected by other objects that can be situated between the camera and the selection element.

Exemplary embodiments of the present invention are directed to a control assembly for a motor vehicle, which can be operated more simply, intuitively and effectively, and a method for the simple, intuitive and effective operation of the control assembly.

According to a first aspect, a control assembly for a motor vehicle, with which control actions carried out by a finger are detectable, has a control device and a selection element, on which a finger is able to be positioned to make a selection, and which is arranged in a predetermined spatial way with respect to the control device, preferably next to and more preferably directly next to the control device, wherein the control device is formed to detect a position of the finger on the selection element and to differentiate between the control actions depending on the detected position.

Presently, the selection element is arranged separately from the operation device. Thus, the selection element can simply be felt by an operator or a passenger without them having to turn their gaze from the road. Depending on the detected position of at least one finger of the operator on the selection element, a corresponding control action can be initiated, with which corresponding functional units of the motor vehicle can be controlled. Thus, a particularly simple, intuitive and secure control is enabled.

According to one embodiment, the control device has a transmitter unit to transmit a signal to the finger and a receiving unit to receive the signal reflected by the finger, wherein the position of the finger on the selection element is able to be determined by means of the received signal. With the help of the transmitter unit and the receiving unit, the position of the finger can be detected three-dimensionally. Such a control device is described in the German patent application with the official file number 102011112567.5, which is referred to here expressly with respect to the specific features of the control device.

The transmitter unit and the receiving unit can be arranged, for example, under the corresponding control surface of the control device. Likewise, it conceivable that the transmitter unit and the receiving unit are arranged directly next to the selection element. The transmitter unit can, for example, transmit light in the infrared wavelength range as the signal. This signal is not able to be recognized by the passenger, whereby they are not disturbed or influenced. The position of the finger over the selection element can also be accurately determined by the transmitter unit and the receiving unit. Thus, corresponding control actions, which are allocated respectively to a predetermined position on and/or over the selection element, can be accurately detected or differentiated.

According to a further embodiment, the selection element has a sensor unit, with which a touching of the selection element with the finger is detectable. The touching of the selection element can additionally be recognized with a corresponding capacitive sensor system. Thus, all information necessary for the functions of the selection element regarding the position of the finger and the state of touching are present. This enables different control actions depending to be differentiated depending on whether the finger is touching the selection element or not. In this way, an extended operating concept is provided.

According to a further embodiment, the sensor unit is formed to detect pressure exerted by the finger in at least one region of the selection element as a control action. Through corresponding sensor equipment, which is coupled to the selection element, a control action can additionally occur through exerting a trigger force on the selection element. Thus, the functionality of the selection element is additionally extended in a simple way.

According to a further embodiment, the selection element contains metal or consists of metal. In order to detect a corresponding touching of this genuine metal selection element with a finger, the entire selection element can be formed as a capacitive sensor electrode. A selection element produced from a metal normally feels different from the components surrounding the selection element, which for example are produced from a plastic. Thus, the selection element can be particularly simply felt without the operator having to turn their gaze from the road. Additionally, a very high level of quality occurs through the optic and the haptic properties of the selection element. The selection element can also be produced from a material other than metal.

According to a further embodiment, the selection element is elevated with respect to the control device. Thus, differentiation between the selection element and the control device is much simpler, whereby the operation is simplified.

According to a further embodiment, the selection element has an actuator, with which a response is able to be emitted and preferably a haptic response is able to be emitted to the finger positioned on the selection element. The actuator can produce a haptic response, through a vibration of the selection element, as a reaction to a control action. For this purpose, either a permanently effective mechanical haptic mechanism (e.g. a micro switch) or a controllable electromechanical haptic mechanism (e.g. a movement sensor combined with an electromagnetic actuator) can be used. In the second case, the actuation haptics can be switched on or off depending on the control action, and different haptic effects can be produced by a different control of the actuator. Herein it is likewise conceivable that the selection element and the control device make use of separate haptic mechanisms or use the same haptic mechanism.

According to a further embodiment, the control device of the control assembly is a touch pad. Additional sensors can be arranged on and/or in the touch pad, with which the position of the finger on the selection element can be detected.

According to a second aspect, a method to operate a control assembly for a motor vehicle involves a detection of a position of a finger on a selection element with a control device arranged in a predetermined spatial way with regard to the selection element and preferably next to or more preferably directly next to the selection element, and a determination of a control action depending on the position of the finger on the selection element.

This control assembly is formed according to the first aspect or the embodiments thereof and has a control device and a selection element arranged separately from this. The control device is formed to detect exactly the position of one or several fingers of an operator on or over the selection element. For this purpose, the control device can, for example, comprise a transmitter unit to transmit a signal to the finger and receiving unit to receive the signal reflected by the finger. The position of the finger can be detected three-dimensionally by means of the transmission time of the signal or an intensity of the received signal.

The selection element is arranged separately from the operating device and can be produced from a different material, particularly from a metal, or can contain a different material. Additionally, the selection element can be elevated with regard to the control device. Thus, the selection element can simply be felt by an operator, without them turning their gaze away from the road. Thus, the control assembly can be operated particularly safely and reliably.

According to one embodiment, the applications of the motor vehicle can be switched between by a control action. The corresponding applications of the motor vehicle can, for example, be depicted on a display element allocated to the control assembly. Such applications can be a navigation system, an entertainment and information system, corresponding data connections or similar. The depiction of the applications on the display element, which can be implemented, for example, in the form of corresponding symbols, can be raised optically accordingly after a touching of the selection element. The operator or the vehicle driver can move his finger along the selection element and thus call up the individual applications. Herein, a corresponding application of the motor vehicle is allocated to each position on the selection element. Combined with the depiction on the display element, the operator always reliably knows that he has positioned his finger correctly on the display element to carry out a corresponding control action and which function he can find where. Thus, a clearly reliable operation of a control assembly occurs.

According to a further embodiment, display elements and/or appliances of the motor vehicle can be switched between through a control action. Through a corresponding control action, it can be selected with at least on finger on the selection element whether the control device is allocated to a combination display, a head unit or an interior mirror. Herein, the control device can be formed as a corresponding touch pad, with which the corresponding appliances of the motor vehicle can be operated. In this way, a simple and reliable operation of the different appliances of the motor vehicle is enabled.

According to a further embodiment, a quantitative adjustment of functional units of the motor vehicle is carried out through the control action. In other words, each time a corresponding adjustment occurs, the selection element will operate it. Such a function can, for example, first be selected with the help of the control device or the touch pad. If the corresponding function is selected, then the actual quantitative adjustment of the corresponding value can occur with the help of the selection element. Such quantitative adjustments can, for example, be the adjustment of treble, the base, the volume or similar of an entertainment and/or information system of the motor vehicle. Likewise, the selection element can be used to adjust the temperature of an air-conditioning system of the motor vehicle accordingly. The corresponding functions or the adjusted values can be depicted on a display element. Herein, currently set values can be displayed through a corresponding back lighting, in order to enable a better orientation. Thus, quantitative functions can be adjusted particularly simply and reliably.

According to a further embodiment, screen content is displaced on a display element allocated to the control assembly through the control action. With the help of the operation of the selection element, content depicted on the display element can be moved to the side in order to make covered regions of the depiction accessible. This can, for example, be used to scroll through websites, the entire depiction of which is larger than the display surface on the display element or on the screen. Additionally, a corresponding region, which can be operated with the control device or with the touch pad, which is smaller than the display on the display element, can be displaced by a corresponding operation of the selection element on the screen depiction. Thus, for example, an exact control of a pointer or cursor is possible within the operable region.

Likewise, globally available positions of the functional units of the motor vehicle can be adjusted with the selection element independently of a display. Thus, for example, the station of a radio can be changed or the volume of the radio can be adjusted independently of the display element. This is particularly advantageous if the display element is momentarily being used for another purpose. A corresponding adjustment with the selection element can, for example, occur through corresponding gestures—for example a swipe with the finger along the selection element or through an absolute positioning of the finger on the selection element. Likewise, the selection element can be formed to detect pressure exerted on the selection element with the finger as a control action. In this way, extended control concepts can be provided.

According to a further embodiment, the selection element has several segments, wherein an application and/or an appliance of the motor vehicle is allocated to each of the segments. If the operator, for example, wants to switch between corresponding applications of the motor vehicle, or would like to control the screen and/or appliances of the motor vehicle, it is advantageous if the selection element is divided logically into several fields. This can, for example, be enabled through a corresponding design or structuring of the selection element. Herein, it is likewise conceivable that the selection element has several segments. Herein, each field is allocated to a corresponding application and/or an appliance. Thus, the operator can select or control the corresponding application and/or appliance of the motor vehicle in a simple way through the touching of the corresponding segment or the corresponding region.

According to a further embodiment, the control device has an actuator with which a response, preferably a haptic response to the finger positioned on the selection element, is emitted depending on the control action. Thus, for example, a haptic response can be emitted to the operator through a corresponding vibration of the selection element. If the operator touches the selection element and moves his finger along the surface of the selection element, the transfer between corresponding regions or segments of the selection element can be signaled through a haptic signal. Thus, a flexible division of the selection element into separated regions is possible. Thus, the operation is clearly simplified.

Furthermore, the selection element of the control assembly can be freely configured by the operator. In other words, the operator can himself select which of the previously named functions are allocated to the selection element or corresponding regions of the selection element. In this way, several of the previously named functions can be allocated to the selection element dynamically according to the situation. Herein, it is, for example, conceivable that a previously defined basic function, for example the main menu control, is called up via a corresponding gesture—e.g. a long pressure on the selection element.

### BRIEF DESCRIPTION OF THE DRAWING FIGURES

The present invention is explained in more detail below by means of the exemplary embodiments with reference to the enclosed drawing.

It shows:

FIG. 1 a schematic depiction of a control assembly for a motor vehicle;

FIG. 2 a schematic depiction of a display of a display element of the control assembly for a motor vehicle; and

FIG. 3 a depiction according to FIG. 1 in the case of an actuated selection element.

### DETAILED DESCRIPTION

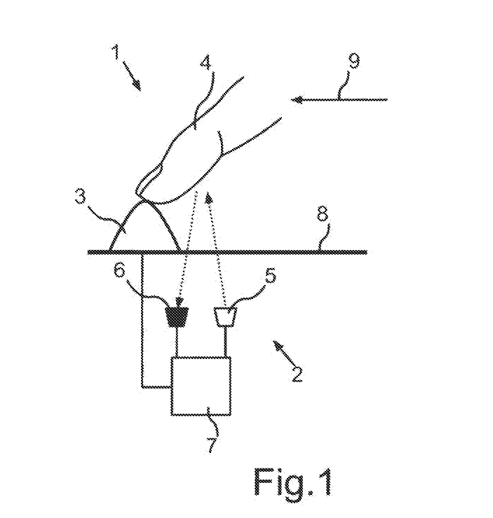

As is shown in FIG. 1, a control assembly 1 has a control device 2 and a selection element 3. A finger 4 is able to be positioned on the selection element 3 to make a selection. The selection element 3 is arranged in a predetermined spatial way, preferably next to and more preferably directly next to the control device 2.

The control device 2 comprises a transmitter unit 5 and a receiving unit 6. The transmitter unit 5 is formed to transmit a signal to the finger 4. Such a signal can be an optical or an electromagnetic signal. Preferably, the signal is light in the infrared wavelength range. The receiving unit 6 is formed to receive the signal reflected by the finger 4. For this purpose, the receiving unit 6 comprises, for example, a corresponding sensor chip, with which the reflected signal can be detected. The transmitter unit 5 and the receiving unit 6 are coupled to a control unit 7. The transmission time of the signal can be calculated with the control unit 7, the signal being transmitted by the transmitter unit 5 and received again by the receiving unit 6. Thus, the position of the finger 4 can be exactly determined by means of the transmission time of the signal. Alternatively, the control unit 7 can determine the position of the finger 4 by means of the intensity of the signal detected by the receiving unit 6.

The transmitter unit 5, the receiving unit 6 and the control unit 7 are arranged under a control surface element 8 on the side facing away from the finger 4. The control surface element 8 is formed such that it can be penetrated by the signal. For this purpose, the transmission factor of the material of the control surface element 8 is selected such that the signal can penetrate through the control surface element 8 without being disrupted.

With the help of the transmitter unit 5 and the receiving unit 6, which are coupled to the control unit 7, the position of the finger 4, which is positioned on the selection element 3, can be exactly determined. Likewise, the position of the finger 4 can be exactly determined in the case that it is positioned above the selection element 3. Thus, different control actions can be differentiated between, according to whether the finger 4 is touching the selection element 3 or not. In order to be able to exactly determine the touching of the selection element 3 with the finger 4, the selection element 3 comprises a sensor, which is not depicted here, for example a capacitive sensor.

Additionally, the selection element 3 can comprise a corresponding sensor unit, with which pressure exerted by the finger 4 on the selection element 3 can be detected. The selection element 3 is likewise coupled to the control unit 7. Thus, for example, the exact position of the finger 4 on the selection element 3 can only be detected after a touching of the selection element 3 with the finger has been detected. For this purpose, a corresponding signal can be transferred from the sensor unit of the selection element 3 to the control unit 7.

The selection element 3 is preferably arranged with regard to the control device 2 such that the finger 4 of an operator always approaches the selection element 3 from the side facing towards the control device 2. The movement of the finger 4 carried out here is presently depicted by the arrow 9.

The selection element 3 is elevated with respect to the control device 2 or the control surface element 8 of the control device 2. Thus, the selection element 3 can be more simply felt with the finger 4. The selection element 3 is preferably produced from a metal. Thus, in comparison to the remaining elements of the surroundings of the selection element 3, which are usually not produced from metal, it can be more easily felt, as the selection element 3 has another haptic and temperature. Thus, an operator or the passenger can touch the selection element 3 practically blindly, without having to turn their gaze away from the road to do so.

For this purpose, the selection element 3 and/or the control device 2 can comprise an actuator, which is not depicted here, with which a haptic response can be emitted to the finger 4. Thus, for example, a corresponding haptic effect can be emitted depending on the control action.

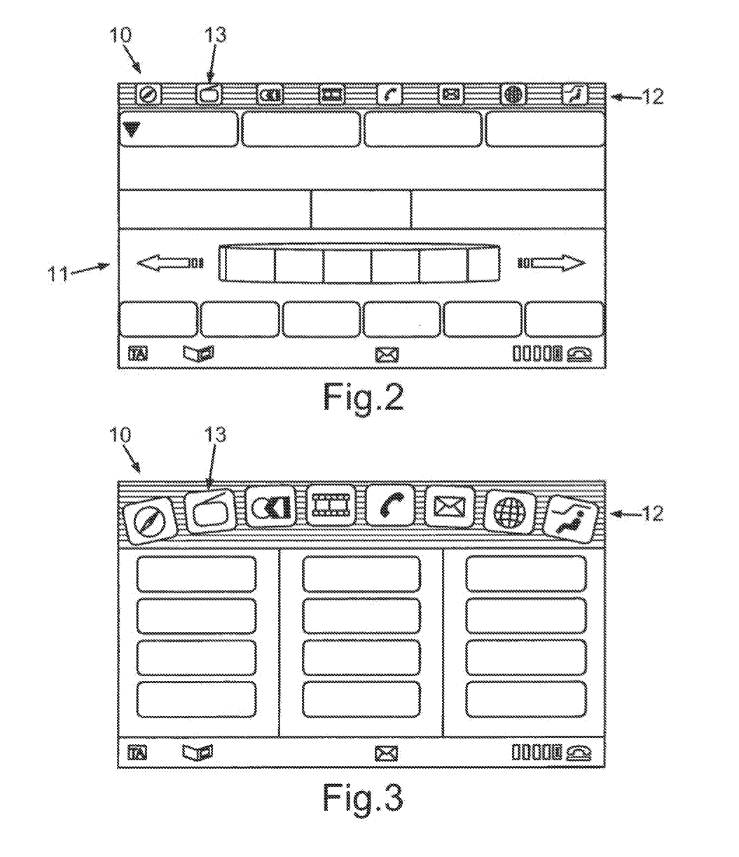

FIG. 2 shows a depiction of a display 10 of a display element of the control assembly 1 for a motor vehicle shown in FIG. 1. This control assembly 1 comprises the selection element 3, on which the finger 4 of the operator or of the driver of the motor vehicle can be positioned. For this purpose, the control arrangement 1 comprises the control device 2, which is preferably arranged next to and more preferably directly next to the selection element 3. The control device 2 is formed to detect a position of the finger 4 on the selection element 3. Depending on the detected position of the finger on the selection element 3, a corresponding control action is determined.

The selection element 3 is arranged separately from the control device 2. The selection element 3 can be elevated with respect to the control device 2. Additionally, the selection element 3 can be produced from a different material, in particular from a metal, or can contain another material, in particular a metal material. Thus, the selection element 3 can be particularly simply felt. The control device 2 can be a corresponding touch pad, which is additionally formed to determine the position of a finger 4 on or over the selection element 3. The selection element 3 can preferably be divided into several segments or regions. Preferably, the selection element 3 can have a corresponding wave shape.

The screen display 10 additionally comprises a depiction 11 of the selection element 3. The screen display 10 comprises a depiction of different functions of the motor vehicle. These are depicted by corresponding symbols and can, for example be selected by operating the control device 2 or the touch pad. In the depiction in FIG. 2, the selection element 3 is not actuated.

In comparison to this, the depiction in FIG. 3 shows a corresponding screen display 10 in which the selection element 3 has been actuated. For this purpose, the selection element 3 can, for example, be touched with a finger 4 of an operator. Herein it is likewise conceivable that a corresponding pressure on the selection element 3 is exerted by the finger 4 of the operator. As a result of the actuation of the selection element 3, a line 12 in the screen display 10 is depicted as being enlarged. Likewise, the individual symbols, which are allocated to corresponding applications of the motor vehicle, are depicted as being enlarged. The symbol 13 of the application selected at that time is optically raised accordingly. Presently, the symbol 13 of the selected application is depicted as being brighter. The corresponding symbols of the applications of the motor vehicle can be selected by means of a movement of the finger 4 over the selection element 3. Herein, a corresponding symbol can be selected by pressure on the selection element 3.

Likewise, screens and/or appliances of the motor vehicle can be switched between with the selection element 3. Additionally, corresponding quantitative functions of the functional units of the motor vehicle can be adjusted accordingly. Furthermore, corresponding screen content, which is depicted on the display element 10, can be displaced.

Although the present invention has previously been described by means of exemplary embodiments with reference to the enclosed drawing, it is understood that different amendments and embodiments can be carried out, without leaving the scope of the pre-sent invention, as is defined in the enclosed claims.

The disclosure of the drawing is exclusively indicated with respect to further features and advantages of the present invention.

1-19. (canceled)

20. A control assembly for a motor vehicle, wherein the control assembly is configured to detect control actions carried out by a finger, the control assembly comprising:
a control device; and
a selection element arranged in a predetermined spatial way with respect to the control device, on which a finger is able to be positioned to make a selection,
wherein the control device is configured to detect a position of the finger on the selection element and to differentiate control actions depending on the detected position.

21. The control assembly according to claim 20, wherein the selection element is arranged directly next to the control device.

22. The control assembly according to claim 20, wherein the control device comprises a transmitter unit configured to transmit a signal to the finger and a receiving unit configured to receive a signal reflected by the finger, wherein the position of the finger on the selection element is determined using the received signal.

23. The control assembly according to claim 20, wherein the selection element comprises a sensor unit configured to detect a touching of the selection element with the finger.

24. The control assembly according to claim 23, wherein the sensor unit is configured to detect pressure exerted with the finger on at least one region of the selection element as a control action.

25. The control assembly according to claim 20, wherein a material of the selection element contains metal or the selection element consists of metal.

26. The control assembly according to claim 20, wherein the selection element is elevated with respect to the control device.

27. The control assembly according to claim 20, wherein the selection element comprises an actuator configured to emit a response.

28. The control assembly according to claim 27, wherein the actuator is configured to emit a haptic response to the finger positioned on the selection element.

29. The control assembly according to claim 20, wherein the control device is a touch pad.

30. A method of operating a control assembly for a motor vehicle with the steps:
detecting a position of a finger on a selection element by a control device arranged in a predetermined spatial way with respect to the selection element; and
determining a control action depending on the detected position of the finger on the selection element.

31. The method according to claim 30, wherein the selection element is arranged directly next to the control device.

32. The method according to claim 30, wherein the control action causes a switching between applications of the motor vehicle.

33. The method according to claim 30, wherein the control action switches between display elements or appliances of the motor vehicle.

34. The method according to claim 30, wherein the control action causes a quantitative adjustment of functional units of the motor vehicle.

35. The method according to claim 30, wherein the control action displaces screen content on a display element allocated to the control assembly.

36. The method according to claim 30, wherein the selection element comprises several segments, and wherein an application or an appliance of the motor vehicle is allocated to or allocatable to each of the segments.

37. The method according to claim 30, further comprising:
emitting a response using an actuator of the control device depending on the control action.

38. The method according to claim 37, wherein the response is a haptic response to the finger positioned on the selection element.
